(19) United States
(12) Patent Application Publication
(10) Pub. No.: US 2024/0120783 A1
(43) Pub. Date: Apr. 11, 2024

(54) WATER-COOLED MOTOR

(71) Applicant: TOYOTA JIDOSHA KABUSHIKI KAISHA, Toyota-shi (JP)

(72) Inventors: Iori MATSUDA, Toyota-shi (JP); Tomokazu SUDA, Toyota-shi (JP); Yuta ABIKO, Toyota-shi (JP); Akihiro MAKINO, Toyota-shi (JP); Shotaro OKAMOTO, Toyota-shi (JP); Daisuke MATSUDA, Hekinan-shi (JP)

(73) Assignee: TOYOTA JIDOSHA KABUSHIKI KAISHA, Toyota-shi (JP)

(21) Appl. No.: 18/479,864

(22) Filed: Oct. 3, 2023

(30) Foreign Application Priority Data
Oct. 5, 2022 (JP) 2022-160950

(51) Int. Cl. H02K 1/20

(52) U.S. Cl. CPC H02K 1/20

(57) ABSTRACT

A water-cooled motor includes: an annular stator having a central axis; and an annular housing surrounding the stator around the central axis and provided with a cooling channel within the housing, the housing includes: an annular non-magnetic metal pipe; and a casting member cast to envelop the metal pipe around the central axis, and the metal pipe is located inward of the cooling channel and located outward of an outer surface of the stator, in a radial direction of the stator.

### CROSS REFERENCE TO RELATED APPLICATIONS

This nonprovisional application is based on Japanese Patent Application No. 2022-160950 filed on Oct. 5, 2022 with the Japan Patent Office, the entire contents of which are hereby incorporated by reference.

### BACKGROUND

### Field

The present disclosure relates to a water-cooled motor.

### Description of the Background Art

Regarding a conventional water-cooled motor, Japanese Patent Laying-Open No. 2021-118590 discloses a technique of cooling a motor body by providing a cylindrical water jacket covering the outer peripheral surface of the motor body and allowing cooling water to flow in the water jacket.

### SUMMARY

For a cooled motor in which a stator is contained in a housing provided with a cooling channel, a casting may be used as the housing. During manufacture, voids may be formed in the casting and, when the stator is fixed by shrink fit to the housing formed by the casting, the inner surface of the housing may be scraped off, which causes a part of the cooling channel and the outer surface of the stator to communicate with each other through the voids. In such a case, it is difficult to stably cool the stator.

The present disclosure is given in view of the problem as described above, and an object of the present disclosure is to provide a water-cooled motor in which its stator can be cooled stably.

A water-cooled motor based on the present disclosure includes: an annular stator having a central axis; and an annular housing surrounding the stator around the central axis and provided with a cooling channel within the housing. The housing includes: an annular non-magnetic metal pipe; and a casting member cast to envelop the metal pipe around the central axis. The metal pipe is located inward of the cooling channel and located outward of an outer surface of the stator, in a radial direction of the stator.

With the above-described configuration, even if the inner surface of the housing formed by a casting is scraped off when the stator is fixed to the housing by shrink fit or the like, it is possible to prevent the cooling channel from communicating with the outer surface of the stator through voids included in the casting, by providing the metal pipe located inward of the cooling channel and located outward of the outer surface of the stator. Accordingly, the stator can be cooled stably.

In the water-cooled motor based on the above disclosure, an inner surface of the metal pipe may abut against the outer surface of the stator.

With the above-described configuration, the stator can be cooled directly by the metal pipe disposed inside the cooling channel. Accordingly, the cooling efficiency can be increased, as compared with the case where another part is interposed between the metal pipe and the outer surface of the stator.

In the water-cooled motor based on the above disclosure, the stator may include a stator core having an end face on one side in an axial direction of the central axis, and an end coil disposed on the end face. The metal pipe may have a protruding portion protruding toward the one side in the axial direction, with respect to the end face. Preferably, the protruding portion is in thermal contact with the end coil with an insulating member in between.

With the above-described configuration, the end coil can be cooled by the protruding portion provided on the metal pipe.

In the water-cooled motor based on the above disclosure, the casting member may include a first wall portion located outward in the radial direction, and a second wall portion located inward of the first wall portion in the radial direction. The cooling channel may be formed in a gap between the first wall portion and the second wall portion. The metal pipe may be located inside the second wall portion in the radial direction. In this case, preferably a thickness of the second wall portion in the radial direction is smaller than a thickness of the first wall portion in the radial direction.

With the above-described configuration, the second wall portion is made thinner so that the distance between the cooling channel and the outer surface of the stator can be reduced, and thus the cooling efficiency can be increased. Moreover, the second wall portion is made thinner so that the manufacturing cost can be reduced.

In the water-cooled motor based on the above disclosure, the thickness of the second wall portion is preferably 5 mm or less. Such a thickness enable increase of the cooling efficiency.

In the water-cooled motor based on the above disclosure, an outer surface of the metal pipe may have an uneven shape.

With the above-described configuration, when the casting member is cast to envelop the metal pipe, the contact area where the outer surface of the metal pipe is in contact with the casting member can be increased. Thus, the thermal conductivity can be increased and accordingly the cooling efficiency can be increased. Moreover, the anchoring effect between the metal pipe and the casting member can be enhanced.

In the water-cooled motor based on the above disclosure, the projections of the metal pipe may each include a top portion located outward in the radial direction, a bottom portion located inward in the radial direction, and a columnar portion connecting the top portion and the bottom portion to each other. In this case, preferably the top portion has an enlarged shape relative to the columnar portion.

With the above-described configuration, the contact area where the outer surface of the metal pipe is in contact with the casting member can further be increased. Thus, the cooling efficiency can further be increased, and the anchoring effect can further be enhanced as well.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view of a water-cooled motor according to Embodiment 1.

FIG. 2 shows a cooling channel for the water-cooled motor according to Embodiment 1.

FIG. 3 is a cross-sectional view along line III-III shown in FIG. 1.

FIG. 4 is an enlarged view of an outer circumferential surface of a metal pipe according to Embodiment 1.

FIG. 5 is a perspective view of a water-cooled motor according to Embodiment 2.

### DESCRIPTION OF THE PREFERRED EMBODIMENTS

In the following, embodiments of the present disclosure are described in detail with reference to the drawings. In the following embodiments, the same or common parts are denoted by the same reference characters in the drawings, and a description thereof is not herein repeated. In connection with the embodiments, while a case is illustrated where the water-cooled motor is a traction motor mounted on a vehicle such as hybrid electric vehicle or electric vehicle, the water-cooled motor is not limited to the traction motor, but is applicable as well to power generator motor, motors for other uses, and motors (including power generator) other than vehicle motors.

### Embodiment 1

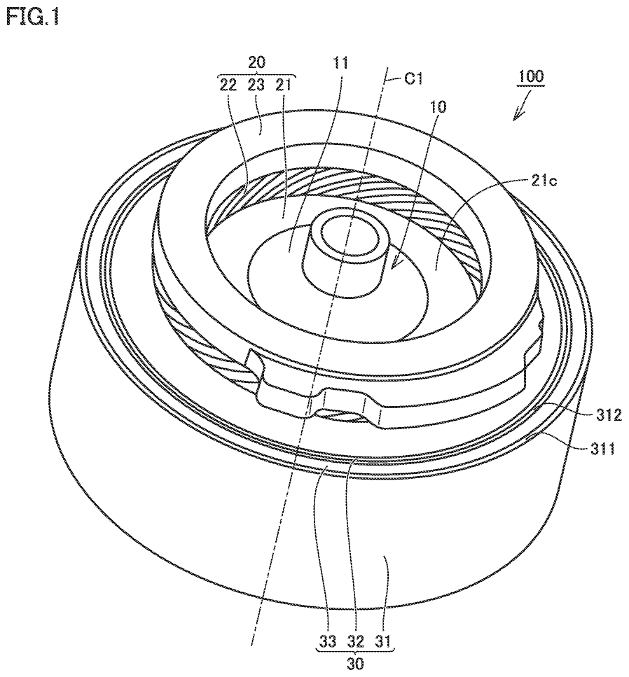

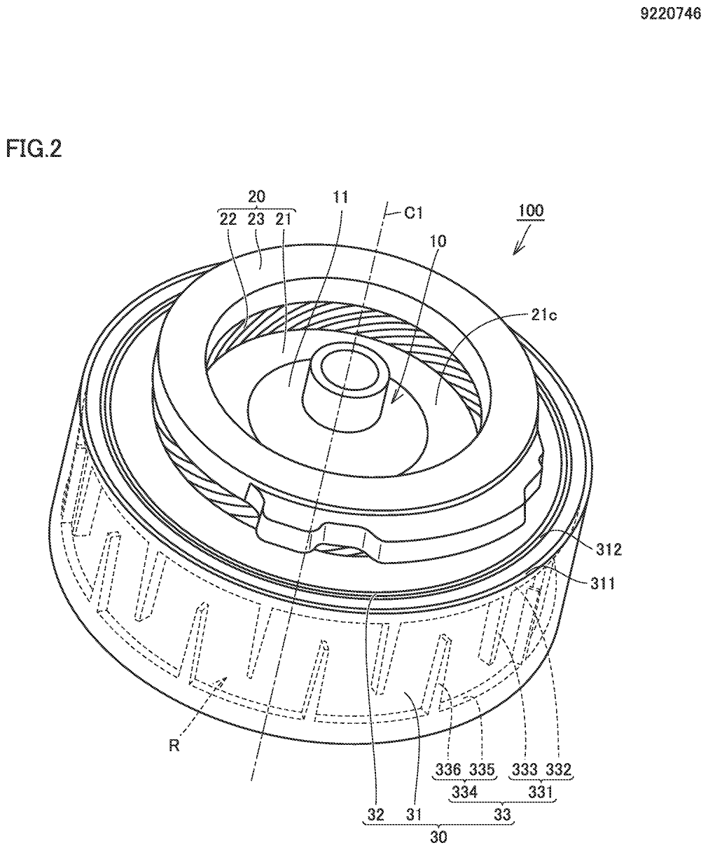

FIG. 1 is a perspective view of a water-cooled motor according to Embodiment 1. FIG. 2 shows a cooling channel for the water-cooled motor according to Embodiment 1. Referring to FIGS. 1 and 2, a water-cooled motor 100 according to Embodiment 1 is described.

As shown in FIGS. 1 and 2, water-cooled motor 100 includes a rotor 10, a stator 20, and a housing 30.

Rotor 10 is connected to a shaft (not shown), and provided to be rotatable around an axis C1. Rotor 10 includes a rotor core 11. Rotor core 11 is formed by stacking a plurality of electromagnetic steel sheets in the axis C1 direction. Rotor core 11 is provided with a plurality of holes (not shown) extending through the core in the direction parallel with the axis C1 direction. In the plurality of holes, respective permanent magnets (not shown) are inserted.

Stator 20 includes a stator core 21, a coil 22 including an end coil, and an insulating cover 23 as an insulating member. Stator 20 has a central axis. The central axis is coincident with aforementioned axis C1. Stator core 21 has a cylindrical shape. Stator core 21 is provided coaxially with axis C1 around the outer periphery of rotor core 11.

Stator core 21 includes a plurality of plates stacked in the axis C1 direction. Each of the plurality of plates is formed by punching an electromagnetic steel sheet, for example.

Stator core 21 includes a back yoke located outward in the radial direction, and a plurality of teeth located inward in the radial direction. The plurality of teeth are arranged to be spaced from each other in the circumferential direction, and a slot is formed between teeth adjacent to each other in the circumferential direction. Coil 22 is attached in the slot.

Stator core 21 has a first end face 21c on one side in the axis C1 direction. The end coil of coil 22 is disposed on first end face 21c. Specifically, a portion of coil 22 that protrudes toward the one side in the axis C1 direction from first end face 21c is the end coil. The end coil is covered with insulating cover 23. The end coil may be disposed on each of the opposite end faces of stator core 21 in the axis C1 direction.

Housing 30 surrounds stator 20 around axis C1. Housing 30 contains stator 20 located inward in the radial direction. Housing 30 is provided with a cooling channel R. In cooling channel R, water flows as refrigerant, so that stator 20 can be cooled.

Housing 30 includes a casting member 31, a metal pipe 32, and a channel forming member 33. Casting member 31 is cast to envelop metal pipe 32 around axis C1. Thus, casting member 31 and metal pipe 32 are integrated into a single part. Casting member 31 is made of a non-magnetic metal material such as aluminum, for example. Metal pipe 32 is disposed annularly and non-magnetic. Metal pipe 32 has a cylindrical shape. Metal pipe 32 is formed by a steel pipe or the like, for example.

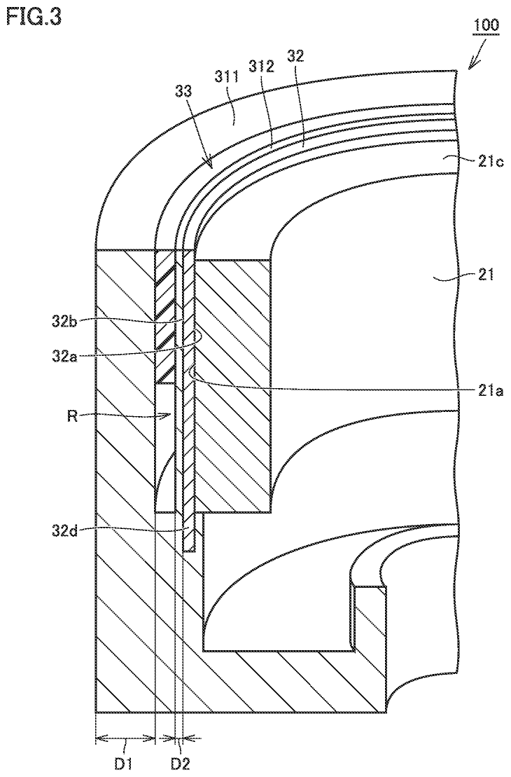

Channel forming member 33 forms a channel in which water as refrigerant flows. Channel forming member 33 may be formed by a resin member. Channel forming member 33 is disposed in a gap between a first wall portion 311 (see FIG. 3) and a second wall portion 312 of casting member 31. Channel forming member 33 includes a first portion 331 and a second portion 334.

First portion 331 is located on one side in the axis C1 direction. First portion 331 includes a first base portion 332 and a plurality of first extending portions 333. First base portion 332 has an annular shape. A plurality of first extending portions 333 are provided to protrude from first base portion 332 toward the other side in the axis C1 direction. The plurality of first extending portions 333 are arranged at predetermined pitches in the circumferential direction.

Second portion 334 is located on the other side in the axis C1 direction. Second portion 334 includes a second base portion 335 and a plurality of second extending portions 336. Second base portion 335 is disposed to face first base portion 332 with a distance in between in the axis C1 direction.

The plurality of second extending portions 336 are provided to protrude toward the one side in the axis C1 direction from second base portion 335. The plurality of second extending portions 336 are arranged at predetermined pitches in the circumferential direction. The plurality of second extending portions 336 are shifted in the circumferential direction from the plurality of first extending portions 333. Between first extending portions 333 adjacent to each other in the circumferential direction, second extending portion 336 is disposed.

Channel forming member 33 is provided in this way, so that cooling channel R is provided to extend circumferentially while meandering. The shape of cooling channel R is not limited to the above-described one. For example, respective shapes of first portion 331 and second portion 334 may be changed in such a manner that cooling channel R extends in the axial direction while meandering.

FIG. 3 is a cross-sectional view along line III-III shown in FIG. 1. Details of water-cooled motor 100 are described with reference to FIG. 3.

Casting member 31 includes first wall portion 311, second wall portion 312, and a connecting portion 313. First wall portion 311 is located outward in the radial direction and forms an outer circumferential wall portion of casting member 31. Second wall portion 312 is located inward in the radial direction, relative to first wall portion 311. Second wall portion 312 is separated from first wall portion 311, so that a gap is formed between first wall portion 311 and second wall portion 312. Aforementioned channel forming member 33 is disposed in the gap to form cooling channel R in the gap. On the other side in the axis C1 direction, first wall portion 311 and second wall portion 312 are connected to each other by connecting portion 313.

Thickness d2 of second wall portion 312 in the radial direction is smaller than thickness d1 of first wall portion 311 in the radial direction. Thickness d2 of second wall portion 312 is preferably 5 mm or less, for example.

Second wall portion 312 can be made thinner to reduce the distance between cooling channel R and the outer surface of stator 20 (more specifically outer circumferential surface 21a of stator core 21), and accordingly increase the cooling efficiency. Moreover, second wall portion 312 can be made thinner to reduce the manufacturing cost.

Metal pipe 32 is located inward of cooling channel R and located outward of outer circumferential surface 21a (see FIG. 3) of stator 20, in the radial direction of stator 20.

Metal pipe 32 has an inner circumferential surface 32a as an inner surface and an outer circumferential surface 32b as an outer surface. Metal pipe 32 has a penetrating portion 32d at the end located on the other side in the axis C1 direction. Penetrating portion 32d penetrates into casting member 31. The periphery of penetrating portion 32d is covered with casting member 31.

Inner circumferential surface 32a of a portion of metal pipe 32 that is located on the one side in the axis C1 direction, with respect to penetrating portion 32d, is not covered with casting member 31 but is exposed from casting member 31. Therefore, this inner circumferential surface 32a of metal pipe 32 abuts against the outer surface of stator 20 (more specifically outer circumferential surface 21a of stator core 21). Consequently, the cooling efficiency can be increased, as compared with the case where another part is interposed between metal pipe 32 and the outer circumferential surface of stator 20. Between inner circumferential surface 32a of metal pipe 32 and the outer circumferential surface of stator 20, a gap may be formed.

While the foregoing illustrates a case where inner circumferential surface 32a of metal pipe 32 located on the one side in the axis C1 direction, with respect to penetrating portion 32d, is exposed from casting member 31, inner circumferential surface 32a of metal pipe 32 is not limited to the above-described one, but may be covered with casting member 31. Specifically, casting member 31 may be interposed between metal pipe 32 and the outer surface of stator 20. In this case, the inner surface of casting member 31 abuts against the outer surface of stator 20 to thereby enable a high cooling efficiency to be maintained.

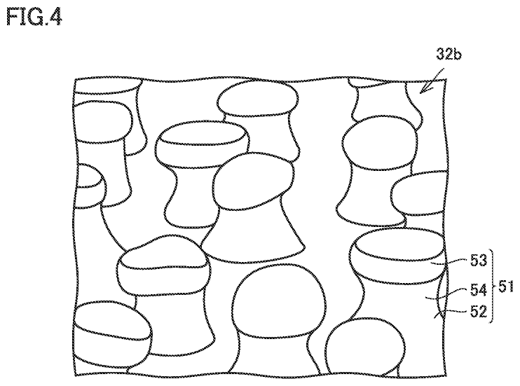

FIG. 4 is an enlarged view of the outer circumferential surface of the metal pipe according to Embodiment 1. Referring to FIG. 4, outer circumferential surface 32b of metal pipe 32 is described.

As shown in FIG. 4, outer circumferential surface 32b of metal pipe 32 has an uneven shape. The uneven shape is formed by a plurality of projections 51 provided on outer circumferential surface 32b. The plurality of projections 51 are each provided to project radially outward from outer peripheral surface 32b.

The plurality of projections 51 each includes a bottom portion 52, a top portion 53, and a columnar portion 54. Bottom portion 52 is located radially inward. Top portion 53 is located radially outward and forms the head portion. Columnar portion 54 connects top portion 53 and bottom portion 52 to each other. Top portion 53 has an enlarged shape relative to columnar portion 54.

Outer peripheral surface 32b has an uneven shape, and therefore, in the state where metal pipe 32 is covered with casting member 31, the contact area where outer peripheral surface 32b is in contact with casting member 31 can be increased. Thus, the thermal conductivity can be enhanced to increase the cooling efficiency. Moreover, protruded portions of the uneven shape penetrate into casting member 31 while casting member 31 penetrates in recessed portions of the uneven shape, so that the anchoring effect between metal pipe 32 and the casting member can be enhanced. Further, the uneven shape is formed by the plurality of projections 51 as described above, so that the contact area can further be increased and the cooling efficiency and the anchoring effect can significantly be enhanced.

Metal pipe 32 provided with a plurality of projections 51 can be formed by centrifugal casting. Specifically, a mold release agent is applied to the inner circumferential surface of a mold, and the mold release agent is heated to be foamed. In this state, a molten metal is injected into the mold, so that a plurality of projections 51 are formed depending on the state of foaming of the mold release agent.

In water-cooled motor 100 according to the present embodiment, stator 20 is fixed to housing 30 by shrink fit. As described above, casting member 31 of housing 30 is formed by a casting. Therefore, when stator 20 (more specifically stator core 21) is shrink-fit into casting member 31, the inner surface of casting member 31 may be scraped off, and voids may be exposed to stator 20.

Even in such a case, metal pipe 32 is located inward of cooling channel R and located outward of the outer surface of stator 20, so that it is possible to prevent the cooling channel from communicating with the outer surface of the stator through the voids. Accordingly, the stator can be cooled stably.

### Embodiment 2

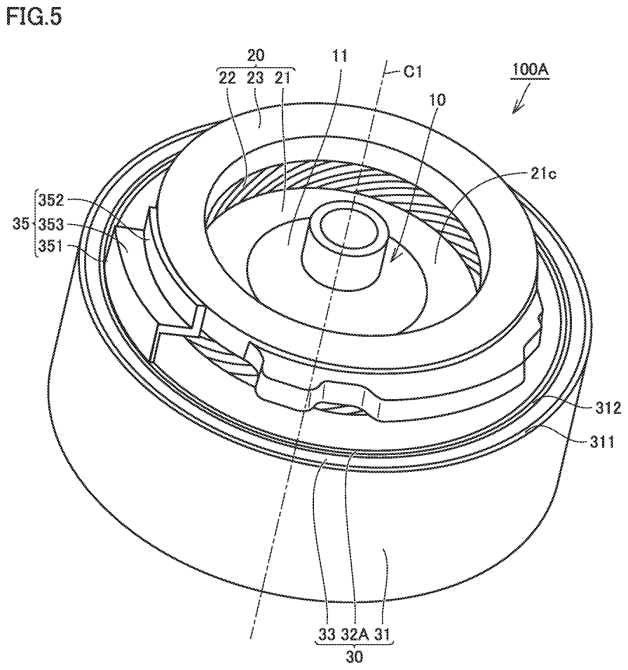

FIG. 5 is a perspective view of a water-cooled motor according to Embodiment 2. As shown in FIG. 5, water-cooled motor 100A according to Embodiment 2 differs from water-cooled motor 100 according to Embodiment 1 in terms of the configuration of a metal pipe 32A. Other features are substantially similar to those of Embodiment 1.

Metal pipe 32A is provided with a protruding portion 35. Protruding portion 35 protrudes toward the one side in the axis C1 direction, with respect to first end face 21c of stator core 21. Protruding portion 35 is in thermal contact with the above-described end coil with insulating cover 23 interposed in between.

Protruding portion 35 has a first piece 351, a second piece 352, and a third piece 353. First piece 351 protrudes from a part of the end of metal pipe 32A, located on the one side in the axis C1 direction, along the axis C1 direction on the one side. Second piece 352 abuts against a part of the peripheral surface of insulating cover 23 along the circumferential direction. Third piece 353 connects first piece 351 and second piece 352 to each other.

The shape of protruding portion 35 is not limited to the above-described one, and first piece 351 may be inclined so as to approach axis C1, toward the one side in the axis C1 direction, to directly contact insulating cover 23. Protruding portion 35 may have an appropriate shape, as long as the portion that protrudes from a part of the end of metal pipe 32A located on the one side in the C1 axis direction, along the one side in the axis C1 direction, is in contact with insulating cover 23.

Such protruding portion 35 can be provided to cool the end coil through protruding portion 35.

Although embodiments of the present disclosure have been described, it should be construed that the embodiments disclosed herein are given by way of illustration in all respects, not by way of limitation. It is intended that the scope of the present disclosure is defined by claims, and encompasses all modifications equivalent in meaning and scope to the claims.

What is claimed is:

1. A water-cooled motor comprising:
an annular stator having a central axis; and
an annular housing surrounding the stator around the central axis and provided with a cooling channel within the housing, wherein
the housing includes:
an annular non-magnetic metal pipe; and
a casting member cast to envelop the metal pipe around the central axis, and
the metal pipe is located inward of the cooling channel and located outward of an outer surface of the stator, in a radial direction of the stator.

2. The water-cooled motor according to claim 1, wherein an inner surface of the metal pipe abuts against the outer surface of the stator.

3. The water-cooled motor according to claim 1, wherein
the stator includes a stator core having an end face on one side in an axial direction of the central axis, and an end coil disposed on the end face,
the metal pipe has a protruding portion protruding toward the one side in the axial direction, with respect to the end face, and
the protruding portion is in thermal contact with the end coil with an insulating member in between.

4. The water-cooled motor according to claim 1, wherein
the casting member includes
a first wall portion located outward in the radial direction, and
a second wall portion located inward of the first wall portion in the radial direction,
the cooling channel is formed in a gap between the first wall portion and the second wall portion,
the metal pipe is located inward of the second wall portion in the radial direction, and
a thickness of the second wall portion in the radial direction is smaller than a thickness of the first wall portion in the radial direction.

5. The water-cooled motor according to claim 4, wherein the thickness of the second wall portion is 5 mm or less.

6. The water-cooled motor according to claim 1, wherein an outer surface of the metal pipe has an uneven shape.

7. The water-cooled motor according to claim 6, wherein
the uneven shape is formed by a plurality of projections provided on the outer surface of the metal pipe,
the projections each include a top portion located outward in the radial direction, a bottom portion located inward in the radial direction, and a columnar portion connecting the top portion and the bottom portion to each other, and
the top portion has an enlarged shape relative to the columnar portion.
